(19) United States
(12) Patent Application Publication
(10) Pub. No.: US 2026/0318369 A1
(43) Pub. Date: Oct. 15, 2026

(54) AUTOMATIC PLANETARY BRAKE CARTRIDGE

(71) Applicant: REV Robotics LLC, Carrollton, TX (US)

(72) Inventors: John HECK, Carrollton, TX (US); Francisco Musiol LIMA, Carrollton, TX (US); Orion Christopher DeYOE, Manchester, NH (US); Kevin MATHEW, Carrollton, TX (US); Craig DANBY, Carrollton, TX (US); Gregory Elliott NEEDEL, Carrollton, TX (US); Jordan NEAL, Carrollton, TX (US); Pablo VIVERO, Carrollton, TX (US); Peter CHAIKOWSKY, Carrollton, TX (US); David Aaron YANOSHAK, Carrollton, TX (US)

(21) Appl. No.: 19/641,047

(22) Filed: Apr. 7, 2026

Related U.S. Application Data
(60) Provisional application No. 63/789,066, filed on Apr. 15, 2025.

(51) Int. Cl. F16D 41/064

(52) U.S. Cl. CPC F16D 41/064

(57) ABSTRACT

A planetary brake cartridge, electromechanical system, and corresponding method. The planetary brake cartridge includes a housing, a throughbore passing through the housing, and a rotating assembly. The throughbore is bounded by a curved sidewall with a radius measured from an axis of rotation. The rotating assembly and the curved sidewall define a set of rotating chambers rotatable about the axis of rotation. The planetary brake cartridge also includes a spacer disposed in each of the set of rotating chambers and a pair of floating pins disposed in each of the set of rotating chambers and separated by the spacer. Rotation of the rotating assembly in a first direction alters a topology of each of the set of rotating chambers and repositions each of the pairs of floating pins in each of the set of rotating chambers to prevent counterrotation of the rotating assembly in a second direction.

### CROSS-REFERENCE TO RELATED APPLICATIONS

This application claims priority to U.S. Provisional Application No. 63/789,066, filed on Apr. 15, 2025, which is hereby incorporated herein by reference in its entirety.

### BACKGROUND

### Technical Field

Novel aspects of the present disclosure relate to the field of rotating mechanical devices and more particularly to a modular planetary brake cartridge that can provide anti-rollback capabilities in electromechanical devices.

### BACKGROUND

Electromechanical devices, such as robots, tools, and vehicles, often incorporate rotating components that are driven by motors. In many applications, it is desirable to prevent unintended rotation of these components when the driving force is removed or interrupted. For example, in lifting mechanisms, robotic arms, or positioning systems, the load or external forces acting on the rotating components may cause them to rotate in an undesired direction when the motor is not actively providing torque. Without adequate anti-rollback mechanisms, such uncontrolled reverse rotation can result in significant damage to mechanical components, including stripped gears, worn bearings, bent shafts, and fractured structural elements. Additionally, the sudden release of stored potential energy during rollback events can cause impact damage to adjacent components, compromise the integrity of precision assemblies, and lead to costly repairs or system failure. In safety-critical applications, the absence of anti-rollback protection may also pose risks to personnel and equipment in the vicinity of the electromechanical device.

### SUMMARY OF THE INVENTION

Novel aspects of the present disclosure are directed to a planetary brake cartridge that comprises a housing, a throughbore passing through the housing, and a rotating assembly. The throughbore is bounded by a curved sidewall with a radius measured from an axis of rotation and the rotating assembly is configured to rotate about the axis of rotation. The rotating assembly and the curved sidewall define a set of rotating chambers rotatable about the axis of rotation. The planetary brake cartridge also includes a spacer disposed in each of the set of rotating chambers and a pair of floating pins disposed in each of the set of rotating chambers and separated by the spacer. Rotation of the rotating assembly in a first direction alters a topology of each of the set of rotating chambers and repositions each of the pairs of floating pins in each of the set of rotating chambers to prevent counterrotation of the rotating assembly in a second direction.

Novel aspects of the present disclosure are also directed to an electromechanical device that includes a planetary brake cartridge and a motor coupled to the planetary brake cartridge. The motor provides an input force to rotate a rotating body, and the planetary brake cartridge prevents counterrotation of the motor and the rotating body. The planetary brake cartridge comprises a housing, a throughbore passing through the housing, and a rotating assembly. The throughbore is bounded by a curved sidewall with a radius measured from an axis of rotation and the rotating assembly is configured to rotate about the axis of rotation. The rotating assembly and the curved sidewall define a set of rotating chambers rotatable about the axis of rotation. The planetary brake cartridge also includes a spacer disposed in each of the set of rotating chambers and a pair of floating pins disposed in each of the set of rotating chambers and separated by the spacer. Rotation of the rotating assembly in a first direction alters a topology of each of the set of rotating chambers and repositions each of the pairs of floating pins in each of the set of rotating chambers to prevent counterrotation of the rotating assembly in a second direction.

Novel aspects of the present disclosure are also directed to a method of operating a planetary brake cartridge that includes a rotating assembly configured to rotate in a throughbore of a housing. Further, the rotating assembly and a curved sidewall of the throughbore form a set of rotating chambers, each of the set of rotating chambers housing a spacer and a pair of floating pins. The method includes the steps of receiving a rotational input force at an input interface of the rotating assembly to cause the rotating assembly to rotate in a first direction and responsive to receiving the rotational input force, changing a topology of each of the set of rotating chambers and repositioning the pair of floating pins in each of the set of rotating chambers to prevent rotation of the rotating assembly in a second direction.

Other aspects, embodiments and features of the invention will become apparent from the following detailed description of the invention when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE FIGURES

The novel features believed to be characteristic of the invention are set forth in the appended claims. The invention itself, however, as well as a preferred mode of use, further objectives and advantages thereof will be best understood by reference to the following detailed description of illustrative embodiments when read in conjunction with the accompanying figures, wherein:

FIG. 1 is a perspective view of an undriven face of a planetary brake cartridge in accordance with an illustrative embodiment;

FIG. 2 is a perspective view of a driven face of a planetary brake cartridge in accordance with an illustrative embodiment;

FIG. 3 is a plan view of the undriven face of the planetary brake cartridge in accordance with an illustrative embodiment;

FIG. 4 is a left side view of the planetary brake cartridge in accordance with an illustrative embodiment;

FIG. 5 is a plan view of a driven face of the planetary brake cartridge in accordance with an illustrative embodiment;

FIG. 6 is a top side view of the planetary brake cartridge in accordance with an illustrative embodiment;

FIG. 7 is a perspective, exploded view of the planetary brake cartridge in accordance with an illustrative embodiment;

FIG. 8 is another perspective, exploded view of the planetary brake cartridge in accordance with an illustrative embodiment;

FIG. 9 is a perspective view of the rotating assembly contained within the housing of the planetary brake cartridge in accordance with an illustrative embodiment;

FIG. 10 is a perspective view depicting the rotatable carrier and splined receiver of the rotating assembly encircled by an annulus in accordance with an illustrative embodiment;

FIG. 11 is a plan view of the undriven face of the planetary brake cartridge in a neutral state according to an illustrative embodiment, but with the corresponding face plate removed;

FIG. 12 is a perspective view of the undriven face of the planetary brake cartridge in a neutral state according to an illustrative embodiment, but with the corresponding face plate removed;

FIG. 13 is a perspective view of the driven face of the planetary brake cartridge in accordance with an illustrative embodiment, but with the corresponding face plate removed; and

FIG. 14 is a schematic diagram of an electromechanical device implementing a planetary brake cartridge in accordance with an illustrative embodiment;

FIG. 15 is a plan view of the undriven face of the planetary brake cartridge in an anti-rollback configuration according to an illustrative embodiment, but with the corresponding face plate removed; and

FIG. 16 is a perspective view of the undriven face of the planetary brake cartridge in an anti-rollback configuration according to an illustrative embodiment, but with the corresponding face plate removed.

### DETAILED DESCRIPTION

Novel aspects of this disclosure provide an improved planetary brake cartridge for preventing undesired rollback. The planetary brake cartridge is also implemented in modular form that facilitates repair and replacement and scalability to permit the same basic design to be adapted for different load capacities and rotational speeds across various applications.

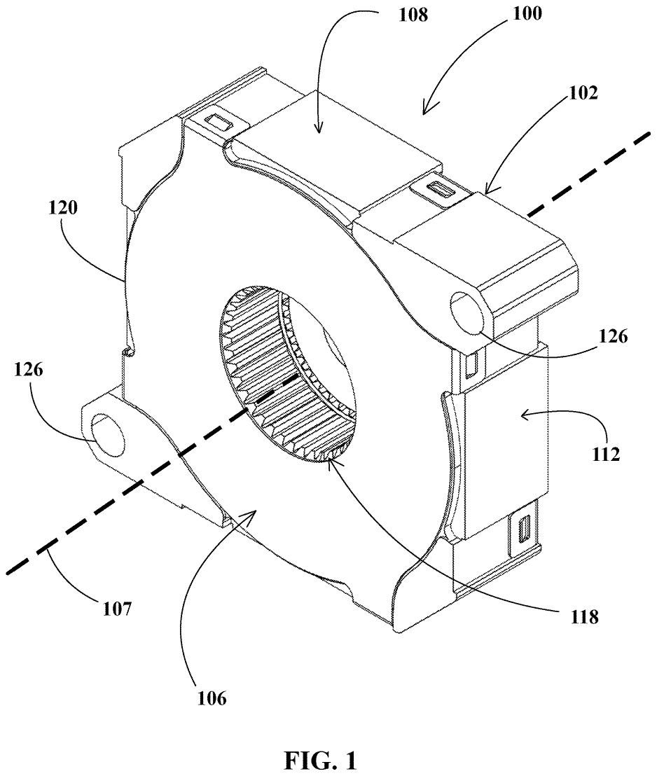

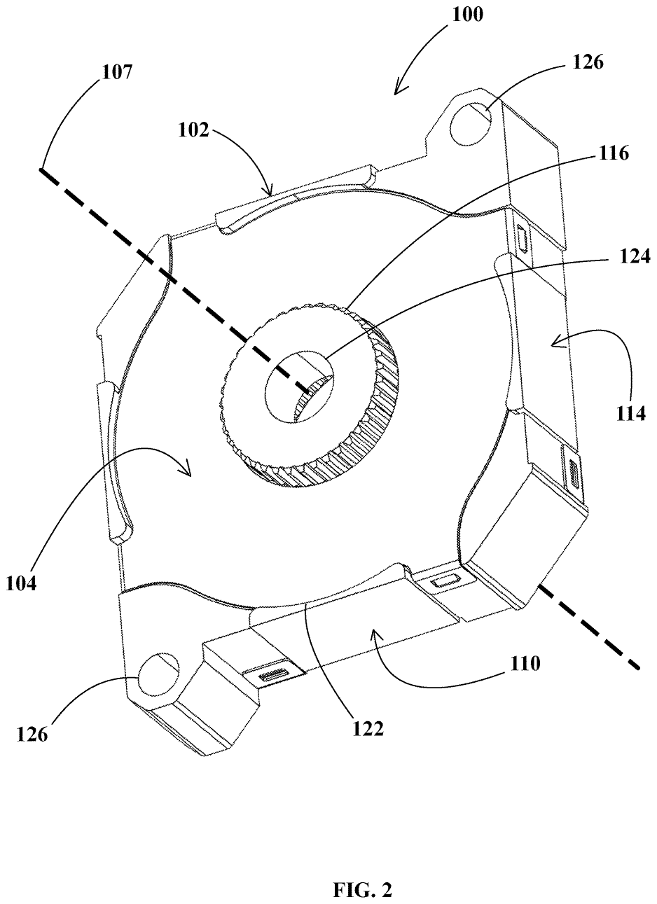

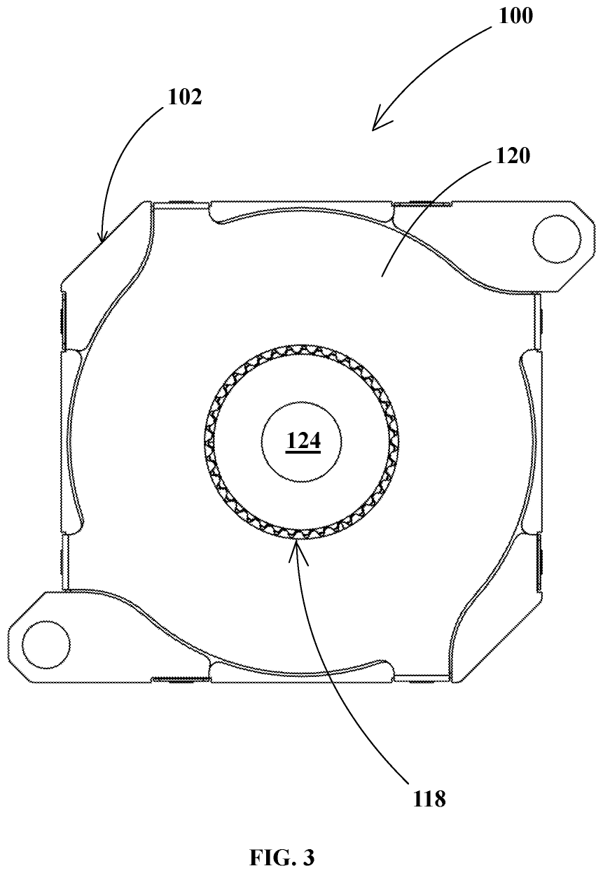

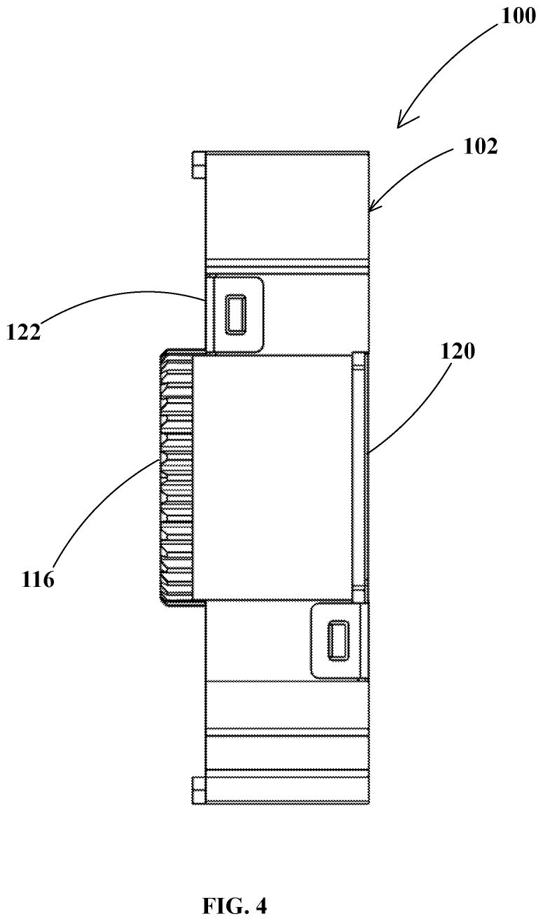

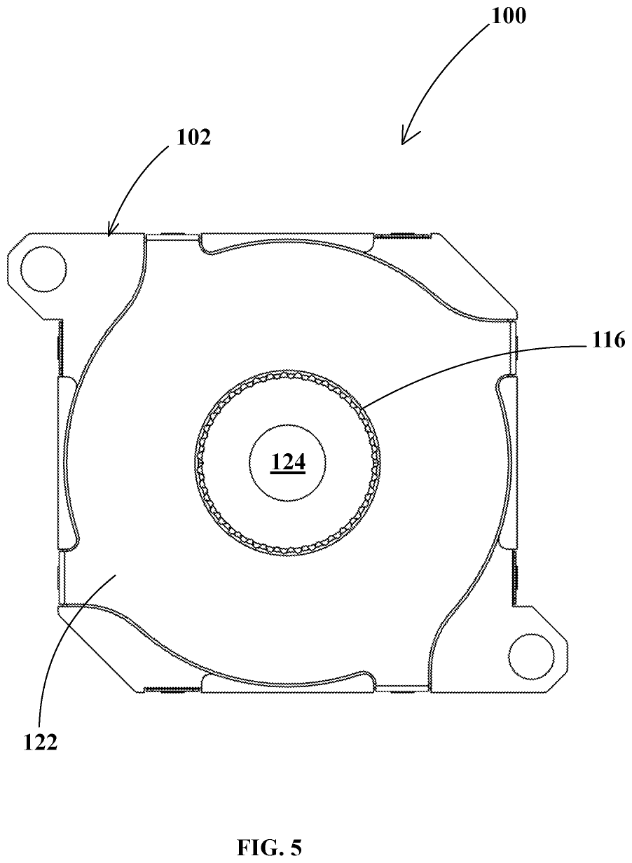

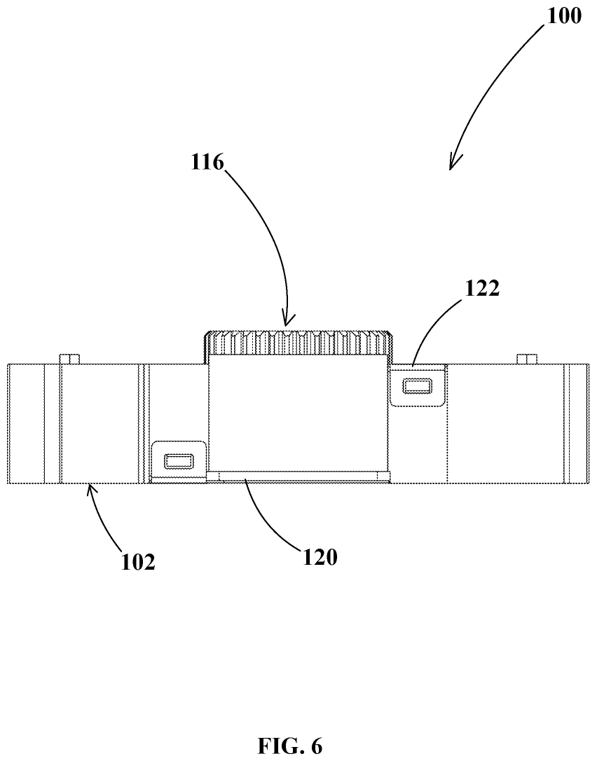

FIGS. 1-6 are various views of a planetary brake cartridge in accordance with an illustrative embodiment. The planetary brake cartridge 100 includes a housing 102 having a driven face 104 opposite an undriven face 106, a top side 108 opposite a bottom side 110, and a right side 112 opposite a left side 114. The faces and sides of the planetary brake cartridge 100 are assigned simply to facilitate discussion and are not meant to be limiting. Accordingly, FIG. 1 is a perspective view of a undriven face 106 of the planetary brake cartridge 100; FIG. 2 is perspective view of an undriven face 106 of the planetary brake cartridge 100; FIG. 3 is a plan view of the driven face 104 of the planetary brake cartridge 100; FIG. 4 is a left side view of the planetary brake cartridge 100; FIG. 5 is a plan view of a driven face 104 of the planetary brake cartridge; and FIG. 6 is a top side view of the planetary brake cartridge 100 in accordance with an illustrative embodiment. The right side view of the planetary brake cartridge 100 is not shown but is the same as the left side view, and the bottom side view of the planetary brake cartridge 100 is not shown but is the same as the top side view.

Generally, a clockwise and/or counterclockwise rotational input force provided to the splined shaft 914 extending outwardly from the driven face 104 will permit a rotating assembly 900 to rotate in concert about axis 107. Thus, a splined output shaft or output gear (not shown) inserted into the splined receiver 904 will also be driven by the rotational input force. In an exemplary embodiment depicted in this disclosure, the rotational input force can transform the topology of the components comprising the rotating assembly 900 so that a cessation of the rotational input force leaves the components of the rotating assembly 900 in an anti-rollback configuration, i.e., a configuration that prevents the splined output shaft or output gear from rotating in the opposite direction.

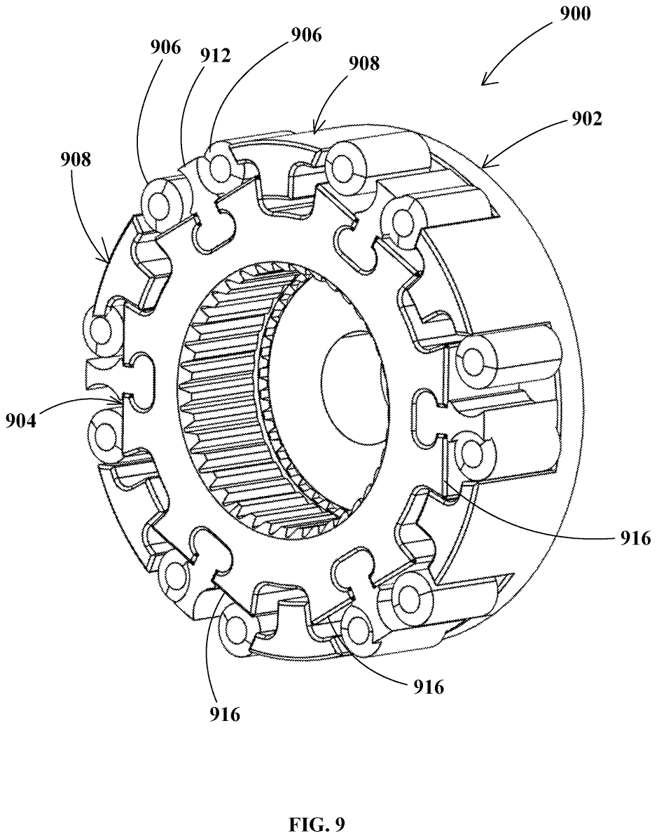

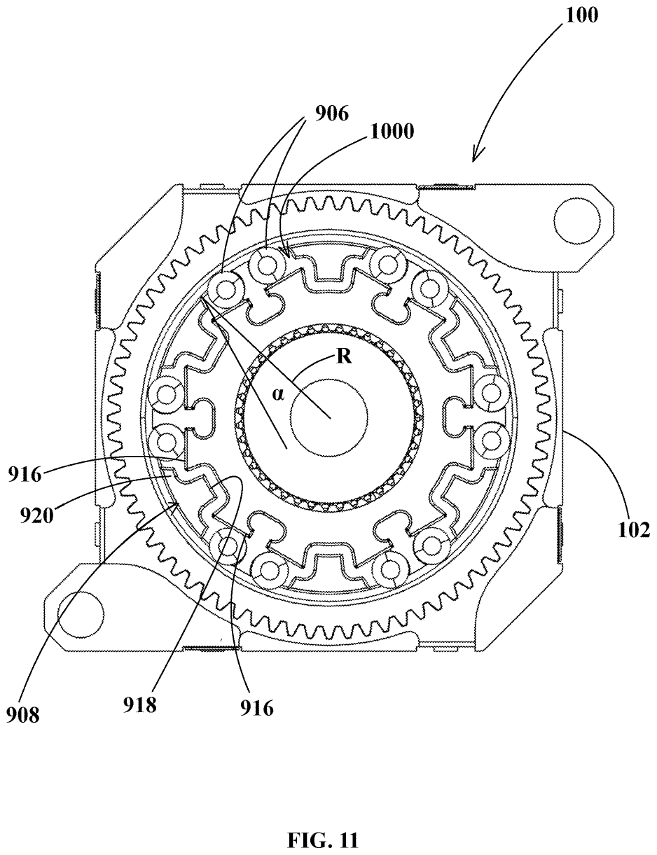

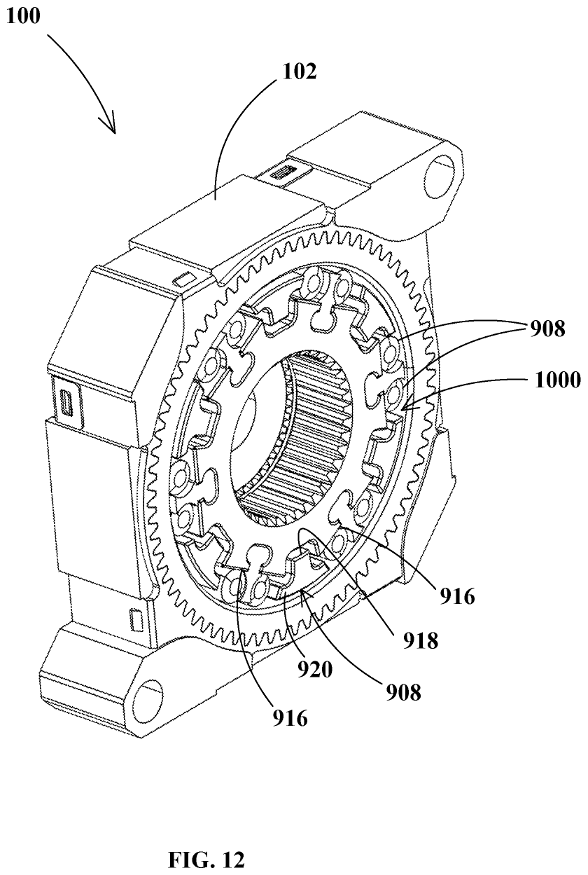

With particular reference to FIG. 1, the undriven face 106 includes a removable face plate 120 having a central aperture leading to the mating surface of a splined receiver 904. Removal of the face plate 120 exposes the rotating assembly 900, which is shown in more detail in FIG. 9. An example of the planetary brake cartridge 100 with the face plate 120 removed is shown in FIGS. 11 and 12.

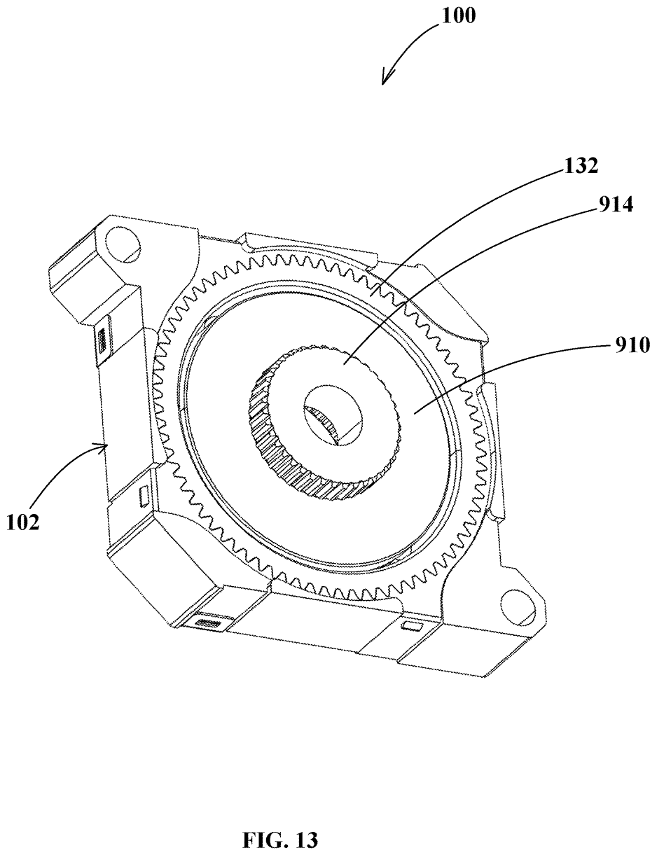

With reference to FIG. 2, a perspective view of the driven face 104 is depicted, showing removable faceplate 122 having a central aperture from which the splined shaft 914 extends. Removal of the face plate 122 exposes the rotating assembly 900, which is shown in more detail in FIG. 9. An example of the planetary brake cartridge 100 with the face plate 122 removed is shown in FIG. 13. The planetary brake cartridge 100 can include a central bore 124 extending through housing 102, which allows objects, e.g., axles, to pass through the housing 102.

The planetary brake cartridge 100 is stackable with other modular components. For example, the planetary brake cartridge 100 can be engaged with another planetary brake cartridge (not shown) such that the input shaft of one planetary brake cartridge can be inserted into the splined receiver of the other planetary brake cartridge and secured together by fasteners inserted through the mounting apertures 126.

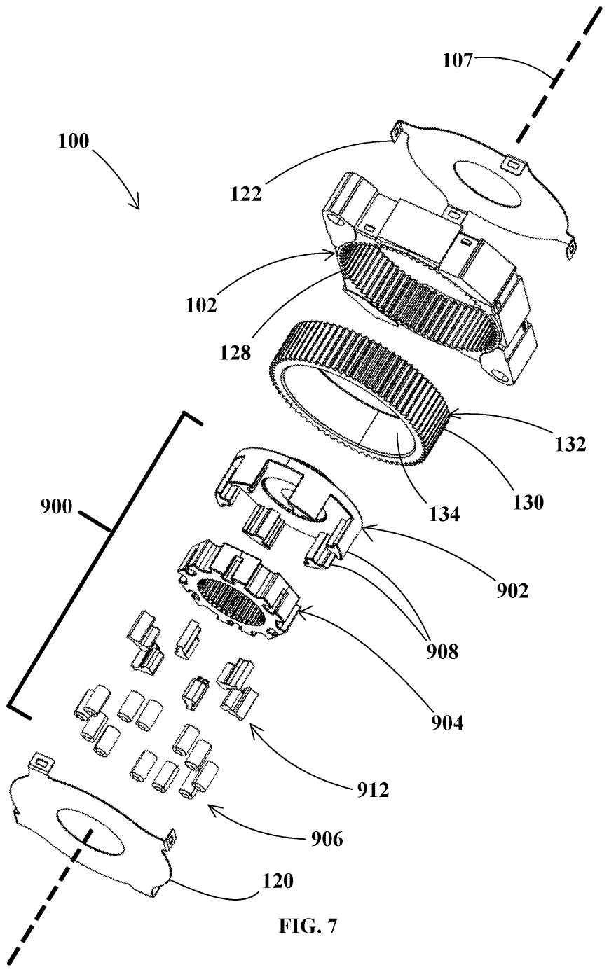

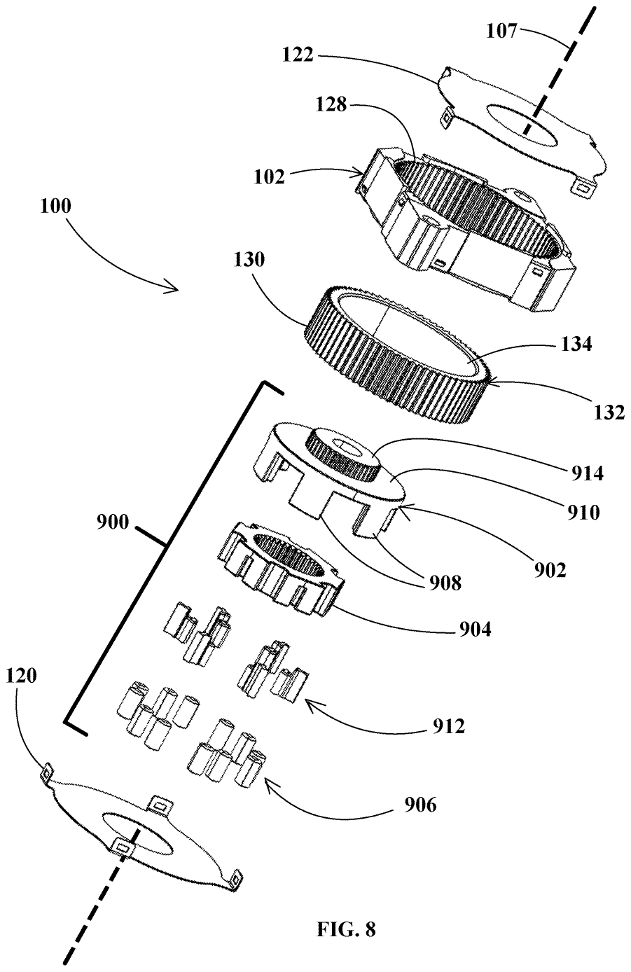

FIGS. 7 and 8 are perspective, exploded views of the planetary brake cartridge 100 in accordance with an illustrative embodiment. The exemplary planetary brake cartridge 100 includes a housing 102 that has a splined inner surface 128, which is configured to mate with the splined outer surface 130 of an annulus 132. The inner surface 134 of the annulus 132 is a hard, precision surface, e.g., a ground steel surface, which can serve as a bearing surface. In the embodiment of the planetary brake cartridge 100 shown in this disclosure, the annulus 132 is a ring gear with teeth disposed about its outer surface. In another embodiment, the splined inner surface 128 of the housing 102 can be replaced by an integrally formed, precision surface, which obviates the need for the annulus 132.

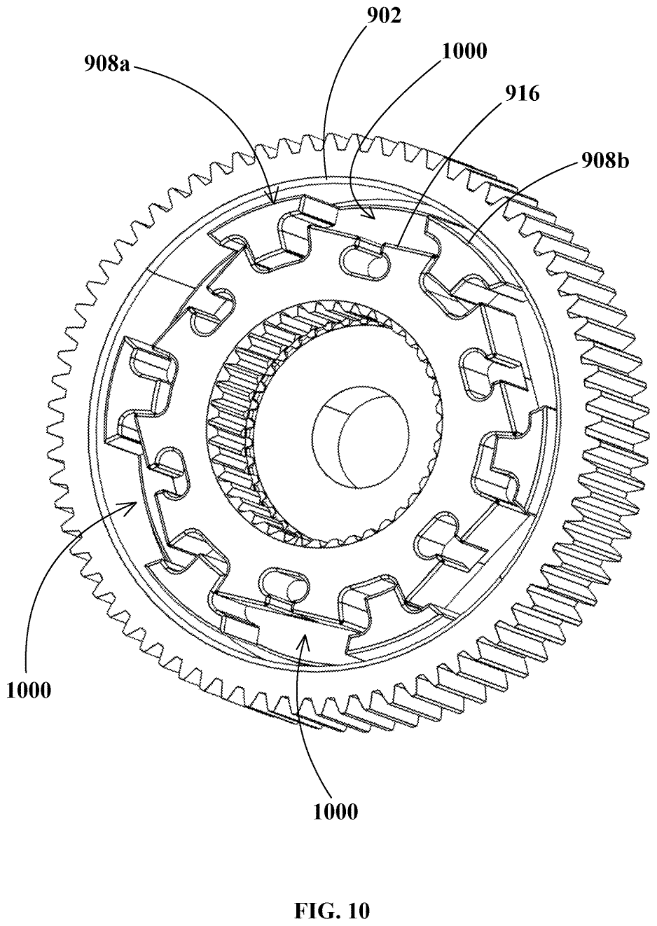

A rotating assembly 900, shown in its assembled form in FIG. 9, is housed at least partially within a volume of space bounded by the inner surface 134 of the annulus 132. The rotating assembly 900 includes a rotatable carrier 902 encircling a coaxially aligned, splined receiver 904, and a plurality of pins 906 positioned about an outer perimeter of the rotating assembly 900. Pairs of pins 906 free float in pin chambers 1000, shown in FIG. 10, each of which is bounded by the inner surface 134 of the annulus 132, the outer gear teeth 916 of the splined receiver 904, and T-shaped posts 908a and 908b, which extend perpendicularly from the base 910 of the rotatable carrier 902. Pairs of pins 906 that share a pin chamber 1000 are separated by a spacer 912 mounted to each gear tooth 916. The spacers 912 can be formed from rigid material that can resist deformation as the pins 900 are urged around inner surface of the annulus 132. In a non-limiting embodiment, the spacers 912 are formed from a polymer material to reduce wear. The exposed portion of each spacer 912 that extends outwardly from its mounting location has a generally bi-concave shape with a curvature can be sized to approximate the curvature of the pins 906.

The rotating assembly 900 includes a splined shaft 914 extending from the base 910 of the rotatable carrier 902, on the side opposite to the T-shaped posts 908. As previously discussed, a rotational input force provided to the splined shaft 914 causes rotation of the rotating assembly 900 about axis 107 along with any rotating body mated with the internal mating surface of the splined receiver 904 via a splined output shaft or output gear (not shown). The rotational input force is transferred from the rotatable carrier 902 to the splined receiver 904 by engagement of the T-shaped posts 908 with gear teeth 916, as can be seen in FIGS. 9 and 10.

In the embodiment shown in this disclosure, the splined shaft 914 is slidably inserted into a splined throughbore of the rotatable carrier 902 so that the rotatable carrier 902 and the splined shaft 914 can rotate in concert. The mating of the splined interfaces can be seen upon closer inspection of FIG. 9. However, in another embodiment, the splined shaft 914 can be integrally formed with the rotatable carrier 902.

FIGS. 11 and 12 are various views of the planetary brake cartridge 100 in a neutral state, i.e., in the absence of rotational motion or an anti-rollback force, and with the corresponding face plate 120 removed. In particular, FIG. 11 is a plan view of the undriven face 106 of the planetary brake cartridge 100, and FIG. 12 is a perspective view of the undriven face 106 of the planetary brake cartridge 100.

As can be seen, each of the pin chambers 1000 houses two pins 906 that are separated from one another by a spacer 912. Each of the pin chambers 1000 is bookended by T-shaped posts 908, and each of the T-shaped posts 908 is formed from a straight leg portion 918 that intersects the middle of an arcuate segment 920. The straight leg portion 918 is oriented radially inwardly and the arcuate segment 920 generally coincides with a circle defining the outer perimeter of the base 910 of the rotatable carrier 902. Opposing ends of the arcuate segment 920 are tapered with an angle a relative to a radial line R that can facilitate the movement of a pin 906 at the trailing edge of the pin chamber 1000 (e.g., the edge formed by T-shaped post 908b in FIG. 10) during rotation of the rotating assembly 900, but which prevents the arcuate segment 920 from dislodging the pin 906 at the leading edge of the pin chamber 1000 (e.g., the edge formed by T-shaped post 908a in FIG. 10) when rotation of the rotating assembly 900 ceases. In a non-limiting embodiment, the angle a is an acute angle. In some embodiments, the angle a is less than 45°, and in other embodiments the angle a is about 30°.

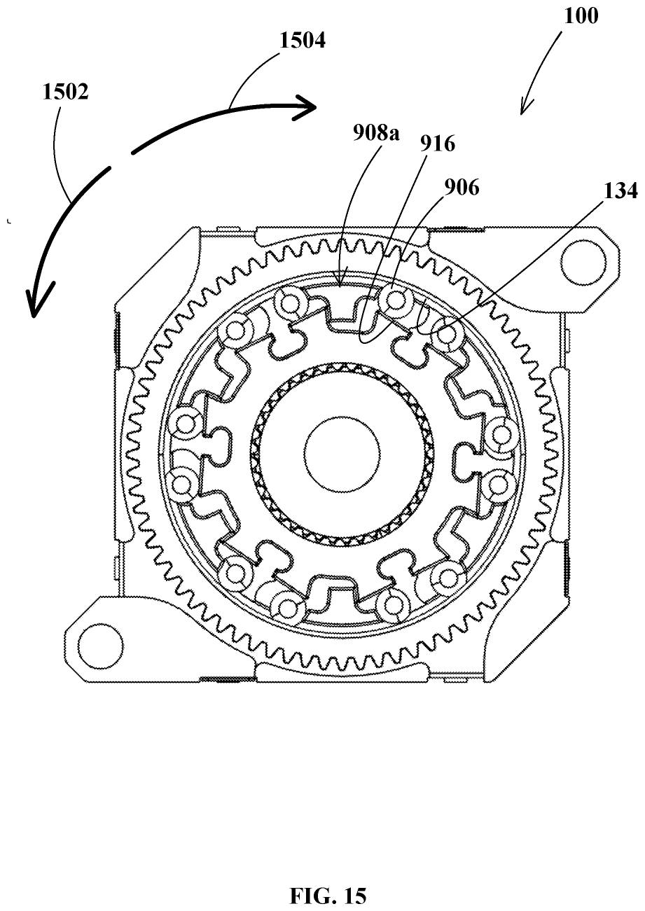

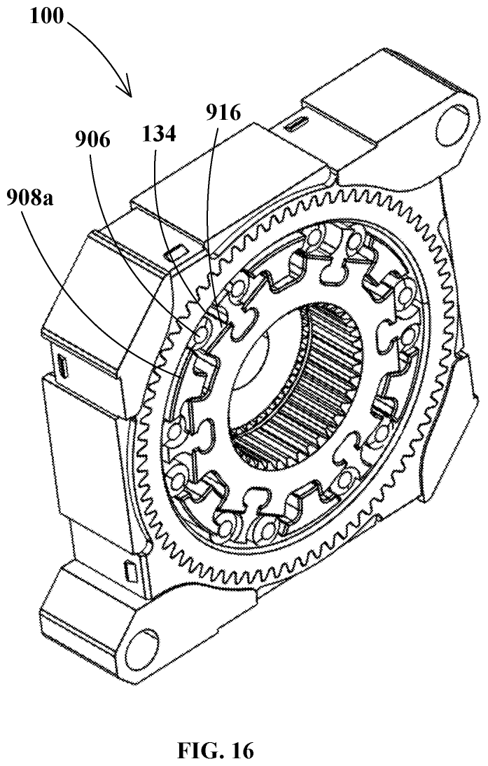

In the neutral state, the straight leg portion 918 of each of the T-shaped posts 908 is positioned centrally in a corresponding gap between two teeth 916. Because the pins 906 free float within their respective pin chambers 1000, pins 906 are centrifugally responsive and can move outwardly in the presence of a rotational input force, as will be shown and described in more detail with regards to FIGS. 15 and 16, below. In the absence of any centrifugal force, the position of the pins 906 within their respective pin chambers 1000 may be marginally affected by non-rotational movement of the planetary brake cartridge 100 and/or by gravitational forces.

FIG. 13 is a view of the driven face of the planetary brake cartridge 100 according to an illustrative embodiment, but with the face plate 122 removed to show the rotating assembly 900 more clearly. The annulus 132 is engaged within a splined inner surface of the housing 102. A rotatable carrier 902 is aligned coaxially within the annulus 132, and a splined shaft 914 extends outwardly from the base 910 of the rotatable carrier 902.

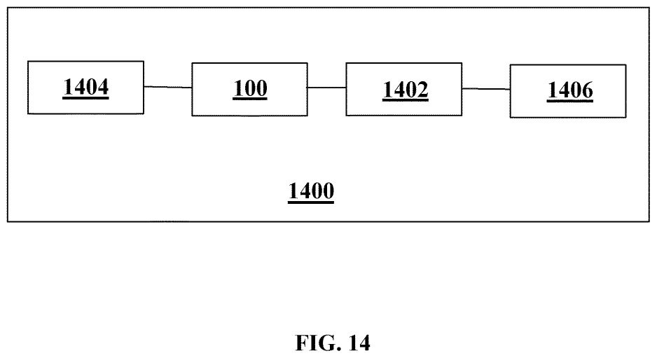

FIG. 14 is a schematic diagram of an electromechanical device 1400 implementing a planetary brake cartridge 100 according to an illustrative embodiment. Non-limiting examples of the electromechanical device 1400 can include a robot, a tool, or a vehicle.

The electromechanical device 1400 includes a planetary brake cartridge 100 mechanically coupled to a motor 1402 and a rotating body 1404. The rotating body 1404 can include a wholly or partially splined shaft or gear to engage with the splined receiver 904 of the planetary brake cartridge 100. A rotational input force provided by the motor 1402 is transferred to the rotating body 1404 by the planetary brake cartridge 100. A cessation of the rotational input force causes the rotating brake assembly components 900 to assume the anti-rollback configuration as shown in more detail in FIGS. 15 and 16 that follow, which prevents unintended rotation.

The motor 1402 is powered by an integrated power supply 1404, which can be a battery. In other embodiments, the power supply 1404 can be an external power supply, such as a power outlet.

FIGS. 15 and 16 are various views of the planetary brake cartridge 100 in an anti-rollback configuration, but with the face plate 120 removed to show the relative position of the various components of the rotating assembly 900. In particular, FIG. 14 is a plan view of the undriven face 106 and FIG. 15 is a perspective view of the undriven face 106.

A rotational input force provided to the splined shaft 914 of the driven face 104 causes an initial movement of the rotatable carrier 902 in the direction of arrow 1502, which then causes the T-shaped posts 908 to contact the teeth 916 of the splined receiver 904, changing the dimensions of each pin chamber 1000 and transferring the rotational input force to the splined receiver 904. The rotatable carrier 902 and the splined receiver 904 rotate together in the direction of arrow 1502. At the same time, each of the pins 906 are forced outwardly by a centrifugal force so that each of the pins 906 travel along the inner surface 134 of the annulus 132. Upon cessation of the rotating input force, the location of one or more of the pins 906 in their respective pin chamber 1000 prevents rollback of the rotating assembly 900. For example, the pin 906 trapped at the leading edge of the pin chamber 1000 by the tapered end of a T-shaped post 908a, the inner surface 134 of the annulus 132, and the outer surface of a gear tooth 916 prevents the rotating assembly 900 from rotating within the annulus 132, which prevents rollback in the direction of arrow 1504.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A planetary brake cartridge, comprising:
a housing;
a throughbore passing through the housing, wherein the throughbore is bounded by a curved sidewall with a radius measured from an axis of rotation;
a rotating assembly configured to rotate about the axis of rotation, wherein the rotating assembly and the curved sidewall define a set of rotating chambers rotatable about the axis of rotation;
a spacer disposed in each of the set of rotating chambers; and
a pair of floating pins disposed in each of the set of rotating chambers and separated by the spacer, wherein rotation of the rotating assembly in a first direction alters a topology of each of the set of rotating chambers and repositions each of the pairs of floating pins in each of the set of rotating chambers to prevent counterrotation of the rotating assembly in a second direction.

2. The planetary brake cartridge of claim 1, wherein the rotating assembly further comprises:
a rotating carrier; and
a splined receiver nested within the rotating carrier, wherein the rotating carrier and the splined receiver are coaxial with the axis of rotation, wherein an input force imparted to an input interface of the rotating carrier causes the rotating carrier to engage with the splined receiver to cause the rotating carrier and the splined receiver to rotate in concert.

3. The planetary brake cartridge of claim 2, wherein:
the splined receiver includes a plurality of gear teeth,
the rotating carrier further comprises a base and a plurality of T-shaped posts arranged around a circumference of the base, and
each of the set of rotating chambers is bounded by one of the plurality of gear teeth, the curved sidewall, and a pair of the T-shaped posts.

4. The planetary brake cartridge of claim 3, wherein rotation of rotating carrier causes the T-shaped posts to engage the plurality of gear teeth to transfer rotational force from the rotating carrier to the splined receiver.

5. The planetary brake cartridge of claim 3, wherein:
each of the T-shaped posts includes a straight leg portion intersecting an arcuate segment,
opposing ends of the arcuate segment are tapered at an acute angle relative to the radius, and
the angle is selected to trap a floating pin from each of the pairs of floating pins at a leading edge in each of the pin chambers to prevent the counterrotation.

6. The planetary brake cartridge of claim 5 wherein rotation of the rotating assembly in a first direction causes each of the pairs of floating pins to move radially outwardly to travel against the curved sidewall.

7. The planetary brake cartridge of claim 1, wherein the curved sidewall is the inner surface of an annular ring disposed within the throughbore of the housing.

8. The planetary brake cartridge of claim 1, wherein the rotating assembly includes:
an input interface configured to receive an input force to rotate the rotating assembly; and
an output interface configured to mate with an input interface of a second planetary cartridge or a rotating body.

9. An electromechanical system comprising:
a planetary brake cartridge; and
a motor coupled to the planetary brake cartridge,
wherein:
the motor provides an input force to rotate a rotating body,
the planetary brake cartridge prevents counterrotation of the motor and the rotating body, and
the planetary brake cartridge includes:
a housing,
a throughbore passing through the housing, wherein the throughbore is bounded by a curved sidewall with a radius measured from an axis of rotation,
a rotating assembly rotating about the axis of rotation, wherein the rotating assembly and the curved sidewall define a set of rotating chambers within the throughbore,
a spacer disposed in each of the set of rotating chambers, and
a pair of floating pins disposed in each of the set of rotating chambers and separated by the spacer, wherein rotation of the rotating assembly in a first direction alters a topology of each of the set of rotating chambers and repositions each of the pairs of floating pins in each of the set of rotating chambers to prevent the counterrotation of the rotating assembly in a second direction.

10. The electromechanical system of claim 9, wherein the rotating assembly further comprises:
a rotating carrier; and
a splined receiver nested within the rotating carrier, wherein the rotating carrier and the splined receiver are coaxial with the axis of rotation, wherein an input force imparted to an input interface of the rotating carrier causes the rotating carrier to engage with the splined receiver to cause the rotating carrier and the splined receiver to rotate in concert.

11. The electromechanical system of claim 10, wherein:
the splined receiver includes a plurality of gear teeth,
the rotating carrier further comprises a base and a plurality of T-shaped posts arranged around a circumference of the base, and
each of the set of rotating chambers is bounded by one of the plurality of gear teeth, the curved sidewall, and a pair of the T-shaped posts.

12. The electromechanical system of claim 11, wherein rotation of rotating carrier causes the T-shaped posts to engage the plurality of gear teeth to transfer rotational force from the rotating carrier to the splined receiver.

13. The electromechanical system of claim 11, wherein:
each of the T-shaped posts includes a straight leg portion intersecting an arcuate segment,
opposing ends of the arcuate segment are tapered at an acute angle relative to the radius, and
the angle is selected to trap a floating pin from each of the pairs of floating pins at a leading edge in each of the pin chambers to prevent the counterrotation.

14. The electromechanical system of claim 13 wherein rotation of the rotating assembly in a first direction causes each of the pairs of floating pins to move radially outwardly to travel against the curved sidewall.

15. The electromechanical system of claim 9, wherein the curved sidewall is the inner surface of an annular ring disposed within the throughbore of the housing.

16. The electromechanical system of claim 9, wherein the rotating assembly includes:
an input interface configured to receive an input force to rotate the rotating assembly; and
an output interface configured to mate with an input interface of a second planetary cartridge or a rotating body.

17. A method of operating a planetary brake cartridge that includes a rotating assembly configured to rotate in a throughbore of a housing, the method comprising:
receiving a rotational input force at an input interface of the rotating assembly to cause the rotating assembly to rotate in a first direction, wherein the rotating assembly and a curved sidewall of the throughbore form a set of rotating chambers, each of the set of rotating chambers housing a spacer and a pair of floating pins; and
responsive to receiving the rotational input force, changing a topology of each of the set of rotating chambers and repositioning the pair of floating pins in each of the set of rotating chambers to prevent rotation of the rotating assembly in a second direction.

18. The method of claim 17, wherein repositioning the pair of floating pins comprises:
urging the pair of floating pins radially outwardly in a presence of centrifugal force; and
causing the pair of floating pins to travel along the curved sidewall.

19. The method of claim 17, further comprising:
trapping one of the floating pins from each of the pairs of floating pins at a leading edge of each of the set of rotating chambers in response to receive a rotational input force in the second direction.

20. The method of claim 17, wherein receiving the rotational input force further comprises:
receiving, by a rotating carrier, the rotational input force; and
transferring the rotational input force from the rotating carrier to a splined receiver nested within the rotating carrier to cause the rotating carrier and the splined receiver to rotate in concert.
